(19) United States
(12) Patent Application Publication
(10) Pub. No.: US 2008/0223402 A1
(43) Pub. Date: Sep. 18, 2008

(54) DISK-SHAPED SUBSTRATE MANUFACTURING METHOD AND WASHING APPARATUS

(75) Inventors: Kazuyuki Haneda, Ichihara-shi (JP); Masahiko Kobayashi, Minamitsuru-gun (JP); Yukinaka Toyama, Minamitsuru-gun (JP)

Correspondence Address: SUGHRUE MION, PLLC, 2100 PENNSYLVANIA AVENUE, N.W., SUITE 800, WASHINGTON, DC, 20037, US

(73) Assignees: SHOWA DENKO K.K., Tokyo (JP); CITIZEN SEIMITSU CO., LTD., Minamitsuru-gun (JP)

(21) Appl. No.: 12/046,103

(22) Filed: Mar. 11, 2008

(30) Foreign Application Priority Data
Mar. 13, 2007 (JP) 2007-063387

(51) Int. Cl. B08B 1/04; B08B 13/00

(52) U.S. Cl. 134/6; 134/115 R

(57) ABSTRACT

The disk-shaped substrate manufacturing method is provided with: scrub-washing a first surface and a second surface of a disk-shaped substrate by respectively using a first porous roller and a second porous roller that have a cylindrical shape and are rotationally driven. The process of the scrub-washing determines a distance between axes of the first porous roller and the second porous roller that sandwich the disk-shaped substrate in between, and performs scrub-washing while the determined distance between the axes is under control.

### CROSS REFERENCE TO RELATED APPLICATIONS

This application is based on and claims priority under 35 USC §119 from Japanese Patent Application No. 2007-63387 filed Mar. 13, 2007.

### BACKGROUND OF THE INVENTION

1. Field of the Invention

The present invention relates to a disk-shaped substrate manufacturing method and a washing apparatus. As the disk-shaped substrate, a glass substrate for magnetic recording medium is exemplified.

2. Description of the Related Art

In recent years, the manufacture of disk substrates as disk-shaped substrates has been activated, under increased demands as recording media. As a magnetic disk substrate that is one of the disk substrates, an aluminum substrate and a glass substrate are used widely. The aluminum substrate is characterized by its high processability and low cost, meanwhile the glass substrate is characterized by its excellent strength, surface smoothness and flatness. In particular, requirements for compact size and high density of disk substrates recently have become extremely high, and the glass substrate of which surface roughness is small and that enables high density has attracted a lot of attention.

In terms of such a magnetic disk substrate, for example, if a large particle is present on the substrate, an error failure is detected in the part having the particle. Especially, the surface of a magnetic disk substrate which has been subjected to a polishing process is activated; thus, such a magnetic disk tends to attract particles. For this reason, removal of particles which are adhered to the surface of a substrate is also an important process as well as maintenance of high surface smoothness in a magnetic disk substrate manufacturing method.

Among the related arts regarding particle removal described in official gazettes, there is an art that provides an apparatus including: a turn table having a cloth (polishing cloth) attached on the upper surface thereof; and a top ring for pressing a semiconductor wafer to the turn table while supporting the semiconductor wafer. In this apparatus, the semiconductor wafer is polished by providing a grinding and polishing liquid from a grinding and polishing nozzle in order to remove minute particles adhered to the polished surface (for example, refer to Patent Document 1).

As another related art described in an official gazette, there is an art which employs an apparatus including: a pair of washing scrub pads; support rollers for supporting a disk between the washing scrub pads while rotationally driving the disk; and nozzles for supplying a washing liquid (for example, refer to Patent Document 2). The washing scrub pads in the Patent Document 2 sandwiches therebetween two disk substrates, which are to be washed, entirely in a diametric direction thereof. In the configuration, both surfaces of the disk substrates in the diametric direction come in contact with the pair of scrub pads along with rotations of the pair of washing scrub pads, and thereby both surfaces of the disk substrates are washed.

[Patent Document 1]

Japanese Patent Application Laid Open Publication No. 10-150008

[Patent Document 2]

Japanese Patent Application Laid Open Publication No. 2002-74653

In conventional scrub-washing, pressing pressure from, for example, an air cylinder is used to press, for example, a roll sponge, a brush, a polishing cloth or the like to a disk to be washed. To be more specific, a particle adhered to the surface of a disk is removed by a physical force of a sponge, a brush, polishing cloth or the like, which is strongly pressed to a relatively large area on the disk surface. However, in such a case where washing is performed by applying physical force to such a relatively large area on the disk, the applied physical force varies according to pressing conditions and pressing sites; thus, uneven washing is likely to occur. Especially, in the case where relatively large areas on a disk are caused to come in contact with the sponge, the brush, the polishing cloth or the like at the same time, the disk is in contact therewith differently from site to site, which causes variations in washing capability among different regions. Thus, uniform washing is difficult.

The present invention is made in order to address the above technical problem and has an object to achieve more stable scrub-washing and thereby to manufacture a good disk-shaped substrate having fewer particles adhered thereto.

### SUMMARY OF THE INVENTION

According to an aspect of the invention, there is provided a disk-shaped substrate manufacturing method including: scrub-washing a first surface and a second surface of a disk-shaped substrate by respectively using a first porous roller and a second porous roller that have a cylindrical shape and are rotationally driven. The process of the scrub-washing determines a distance between axes of the first porous roller and the second porous roller that sandwich the disk-shaped substrate in between, and performs scrub-washing while the determined distance between the axes is under control.

In the condition in which “the determined position between the axes is under control,” upon causing a first porous roller and a second porous roller to stop at a position having a predetermined distance between the axes thereof, the first porous roller and the second porous roller are caused to come in contact with a disk-shaped substrate.

In one aspect of the disk-shaped substrate manufacturing method, the first porous roller and the second porous roller are driven to reciprocate in a radial direction of the disk-shaped substrate.

In another aspect of the disk-shaped substrate manufacturing method, the first porous roller and the second porous roller come in contact with the disk-shaped substrate within a range of one-half of a difference between an external diameter and an internal diameter of the disk-shaped substrate, by driven to reciprocate.

In further aspect of the disk-shaped substrate manufacturing method, the first porous roller and the second porous roller have an Asker F hardness in a range from 80 to 95.

According to another aspect of the invention, there is provided a washing apparatus that performs scrub-washing on a first surface and a second surface of a disk-shaped substrate while supplying a washing liquid. The washing apparatus is provided with: a first porous roller that is able to come in contact with the first surface of the disk-shaped substrate and has a cylindrical shape; a second porous roller that is arranged so as to face the first porous roller, is able to come in contact with the second surface of the disk-shaped substrate, and has a cylindrical shape; and an axis-to-axis distance changing mechanism that changes a distance between axes of the first porous roller and the second porous roller. The axis-to-axis distance changing mechanism stops the first porous roller and the second porous roller at a predetermined axis-to-axis distance, and causes the first porous roller and the second porous roller to come in contact with the disk-shaped substrate.

In one aspect of the washing apparatus, the washing apparatus is further provided with: a rotary mechanism that rotates the first porous roller and the second porous roller that are in contact with the disk-shaped substrate after the first porous roller and the second porous roller are moved and stopped at the predetermined axis-to-axis distance by the axis-to-axis distance changing mechanism; and a reciprocating moving mechanism that reciprocates, in a radial direction of the disk-shaped substrate, the first porous roller and the second porous roller rotated by the rotary mechanism while stopped at the predetermined axis-to-axis distance by the axis-to-axis distance changing mechanism.

In another aspect of the washing apparatus, the reciprocating moving mechanism reciprocates the first porous roller and the second porous roller to bring the first porous roller and the second porous roller in contact with the disk-shaped substrate within a range of one-half of a difference between an external diameter and an internal diameter of the disk-shaped substrate, and causes the first porous roller and the second porous roller to reciprocate a plurality of number of times.

In further aspect of the washing apparatus, the axis-to-axis distance changing mechanism includes a first servo motor that moves the first porous roller and a second servo motor that moves the second porous roller, and controls the predetermined axis-to-axis distance.

### BRIEF DESCRIPTION OF THE DRAWINGS

Exemplary embodiment (s) of the present invention will be described in detail based on the following figures, wherein:

FIG. 1A to FIG. 1H are diagrams illustrating respective processes of the manufacturing method of a disk-shaped substrate (a disk substrate) to which the exemplary embodiments are applied;

FIG. 2 is a view showing the overall configuration of the scrub washing system which performs the scrub washing process;

FIG. 3 is an outline view for explaining the scrub washing apparatus to which the present exemplary embodiment is applied;

FIG. 4 is an explanatory view illustrating the state in which the pair of porous rollers (the first porous roller that may come in contact with a first surface of the disk-shaped substrate, and the second porous roller that may come in contact with a second surface of the disk-shaped substrate) of the scrub washing apparatus scrub-wash the disk-shaped substrate to be washed.

FIG. 5 is a flowchart which illustrates the scrub washing process; and

FIG. 6 is a view illustrating a different example of the scrub washing apparatus.

### DETAILED DESCRIPTION OF THE EMBODIMENTS

Hereinafter, exemplary embodiments of the present invention will be described in detail with reference to the attached drawings.

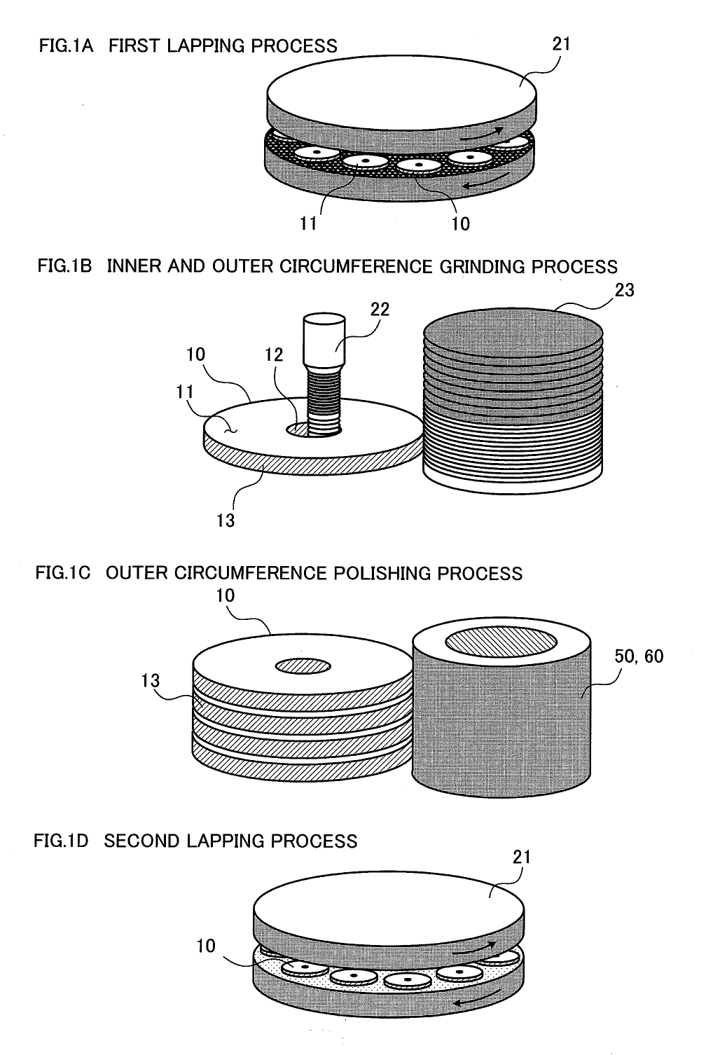

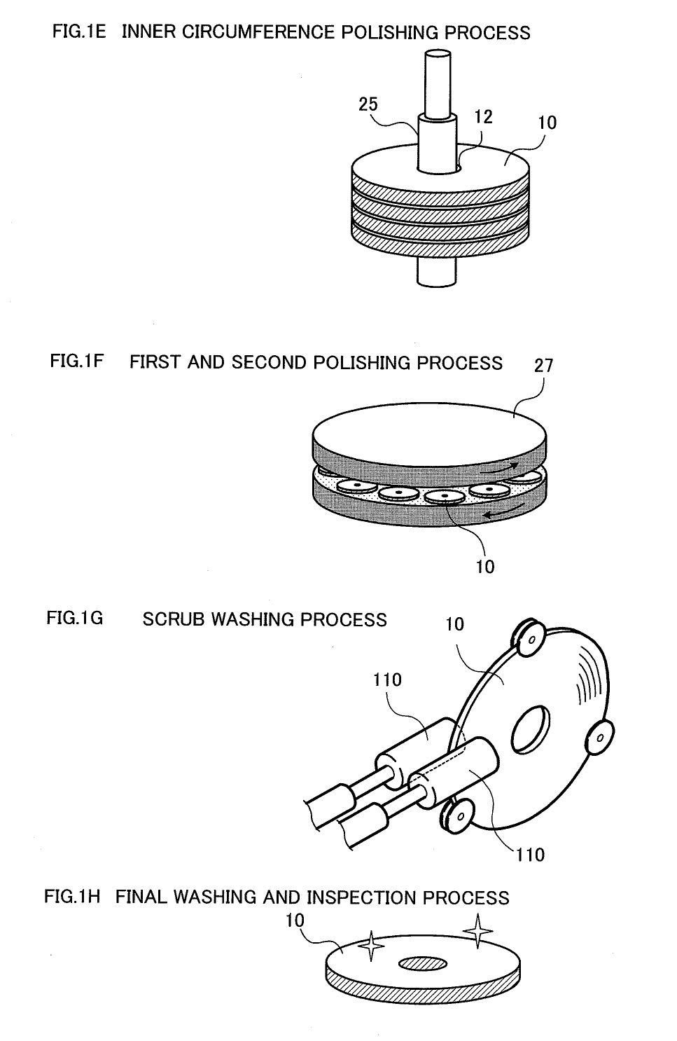

FIG. 1A to FIG. 1H are diagrams illustrating respective processes of the manufacturing method of a disk-shaped substrate (a disk substrate) to which the exemplary embodiments are applied. In respective processes of this manufacturing method, first, in a first lapping process shown in FIG. 1A, raw materials of disk-shaped substrates (workpieces) 10 are put on a fixed base 21, and flat surfaces 11 of the disk-shaped substrates 10 are ground. At this moment, on the surface of the fixed base 21 on which the disk-shaped substrates 10 are put, for example, abrasives of diamond are dispersed and spread.

Next, in an inner and outer circumference grinding process shown in FIG. 1B, an inner circumference 12 of a portion having a hole formed at the center of the disk-shaped substrate 10 is ground by an inner circumference grind stone 22, and the outer circumference 13 of the disk-shaped substrate 10 is ground by an outer circumference grind stone 23. At this moment, the surface of the inner circumference 12 (an inner circumferential face) and the surface of the outer circumference 13 (an outer circumferential face) of the disk-shaped substrate 10 are held in the radial direction of the disk-shaped substrate 10 and processed at the same time by the inner circumference grind stone 22 and the outer circumference grind stone 23, and thereby coaxial degrees are easily secured. On the surfaces of the inner circumference grind stone 22 and the outer circumference grind stone 23, for example, abrasives of diamond are dispersed and spread.

In an outer circumference polishing process shown in FIG. 1C, first, the outer circumferences 13 of the disk-shaped substrates 10 ground in the inner and outer circumference grinding process shown in FIG. 1B is brush-polished using an abrasive-grain inclusion brush 50 which is a brush for polishing an outer circumference while supplying slurry (polishing liquid), and then, brush polishing is carried out using a resin brush 60 while supplying slurry.

Thereafter, in a second lapping process shown in FIG. 1D, the disk-shaped substrates 10 are mounted on the fixed base 21, and the flat surfaces 11 of the disk-shaped substrates 10 are further ground.

Next, in an inner circumference polishing process shown in FIG. 1E, a inner circumference polishing brush 25 is inserted into the portions having the hole at the center of the disk-shaped substrates 10, and the inner circumference 12 of the disk-shaped substrates 10 are polished. Thereafter, in a first and second polishing process shown in FIG. 1F, the disk-shaped substrates 10 are mounted on the fixed base 27, and the flat surfaces 11 of the disk-shaped substrates 10 are polished. In the polishing at this moment, for example, hard polisher is used as non-woven cloth (polishing cloth) in the first polishing process, and the flat surfaces are polished by use of soft polisher in the second polishing process.

Subsequently, in a scrub washing process shown in FIG. 1G, the surfaces of the disk-shaped substrate 10 (both flat surfaces 11) are scrub-washed to remove particles adhered thereto by use of two cylindrical porous rollers 110.

Thereafter, in a final washing and inspection process shown in FIG. 1H, washing and inspection are carried out, and thereby the disk-shaped substrates 10 as a disk substrate are manufactured.

The scrub washing process shown in FIG. 1G, which is a process characterized by the present exemplary embodiment, will be described below in detail.

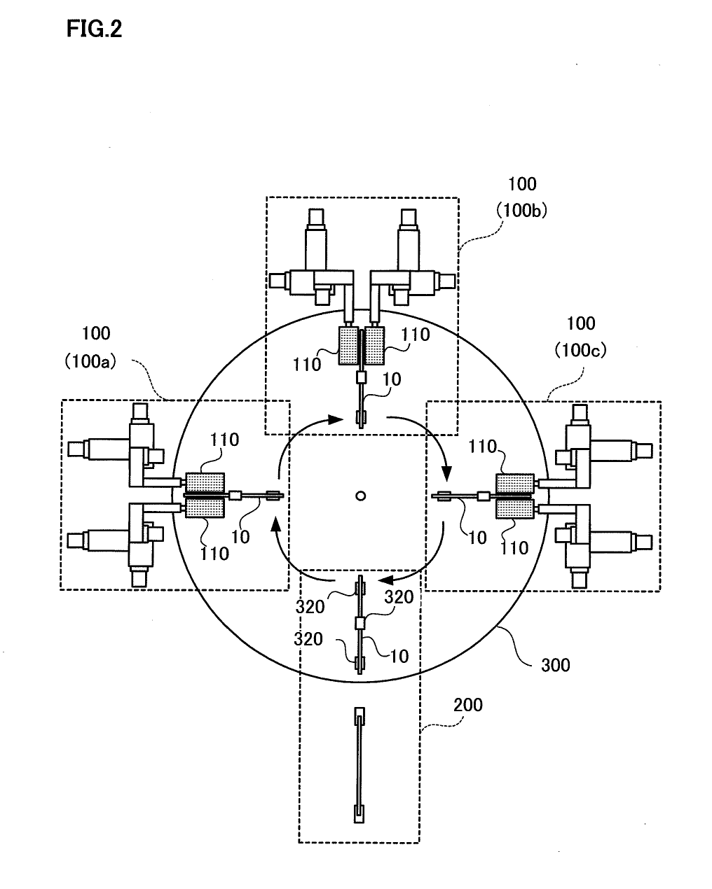

FIG. 2 is a view showing the overall configuration of the scrub washing system which performs the scrub washing process. In the scrub washing system shown in FIG. 2, four processes are performed at the same time in a washing area 300 where a washing operation is performed. In this configuration, an attachment and detachment apparatus 200 which attaches and detaches the disk-shaped substrate 10 as a workpiece, and three scrub washing apparatuses 100 (100a, 100b, and 100c) for performing a three-step (three-stage) scrub-washing, are arranged orthogonally to each other having distances thereamong in the washing area 300. The compartments of these three scrub washing apparatuses 100 (100a, 100b, and 100c) are isolated from each other by shutters (not shown in the figure), and a different washing liquid is sprayed (supplied) for washing in each compartment.

In the attachment and detachment region, the attachment and detachment apparatus 200 picks up, by using a predetermined pick-up apparatus (not shown in the figure), the disk-shaped substrate 10 to be scrub-washed which has been transferred via, for example, a conveyer (not shown in the figure), and then attaches the disk-shaped substrate 10 to a rotary supporting portion 320 in the washing area 300. For example, in the case where there are three rotary supporting portions 320, firstly, two of the rotary supporting portions 320 support the disk-shaped substrate 10, then the third rotary supporting portion 320 is caused to come in contact with the disk-shaped substrate 10; thus, the disk-shaped substrate 10 is supported at three points.

The disk-shaped substrate 10 supported by the rotary supporting portions 320 in the washing area 300 is rotated 90 degrees (clockwise in the case shown in FIG. 2) in the washing area 300, and then subjected to the first-step scrub-washing in the first scrub washing apparatus 100 (100a). In the first-step scrub-washing, scrub-washing is performed by the spray of, for example, an acidic washing liquid including a surfactant. The disk-shaped substrate 10 which has been subjected to the first-step scrub-washing is then caused to rotate 90 degrees (clockwise in the case shown in FIG. 2) in the washing area 300, and then subjected to the second-step scrub-washing in the second scrub washing apparatus 100 (100b). In the second-step scrub-washing, scrub-washing is performed by the spray of, for example, an alkaline washing liquid including a surfactant. Thereafter, the disk-shaped substrate 10 which has been subjected to the second-step scrub-washing is caused to rotate 90 degrees (clockwise in the case shown in FIG. 2) in the washing area 300, and then subjected to the third-step scrub-washing in the third scrub washing apparatus 100 (100c). In the third-step scrub-washing, scrub-washing is performed by the spray of, for example, a washing liquid which is RO (reverse osmosis) water or ultrapure water.

After the third-step scrub-washing is performed in the third scrub washing apparatus 100 (100c), the disk-shaped substrate 10 which has been washed is caused to rotate 90 degrees (clockwise in the case shown in FIG. 2) in the washing area 300, and then to move to the attachment and detachment region. The attachment and detachment apparatus 200 provided in the attachment and detachment region retracts one of the rotary supporting portions 320 (for example, the upper rotary supporting portion 320), picks up the disk-shaped substrate 10 having been scrub-washed by using a predetermined pick-up apparatus (not shown in the figure) to remove the disk-shaped substrate 10 from the washing area 300. The disk-shaped substrate 100 having been scrub-washed and removed from the washing area 300 is transferred to a storage place, which is not shown in the figure.

Next, a description is given to the scrub washing apparatuses 100 (100a, 100b, and 100c).

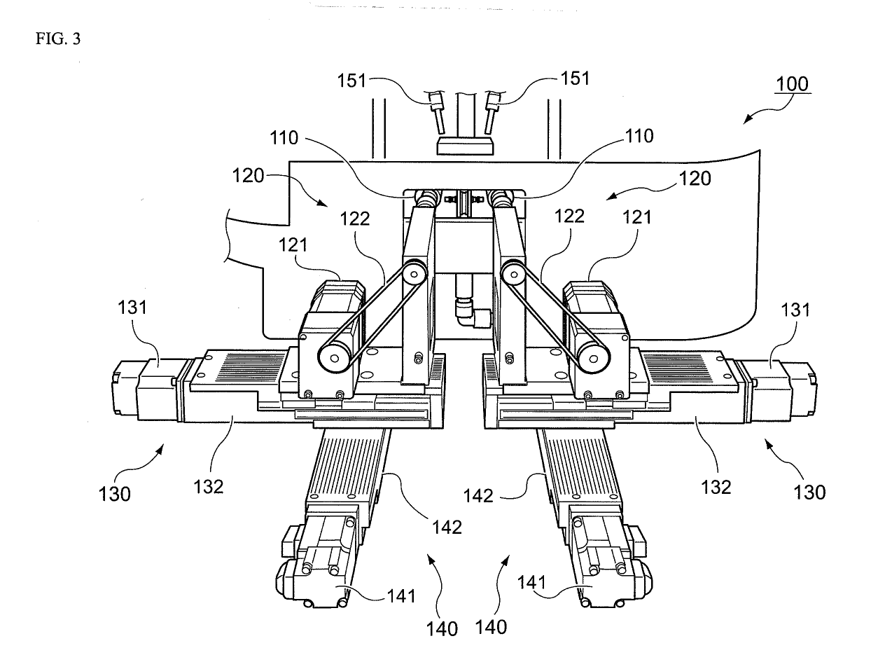

FIG. 3 is an outline view for explaining the scrub washing apparatus 100 to which the present exemplary embodiment is applied. The scrub washing apparatus 100 includes a pair of cylindrical porous rollers 110 which sandwich therebetween the disk-shaped substrate 10 with both surfaces (a first surface and a second surface) thereof, and which rotate while being in contact with the disk-shaped substrate 10. In addition, two rotary mechanisms 120 are also provided as a mechanism to rotate the respective porous rollers 110. Each of the rotary mechanisms 120 includes a roller driving motor 121, which is a driving source for rotating the porous roller 110, and a driving mechanism 122 for transmitting the driving force of the roller driving motor 121 to the porous roller 110. As for the driving mechanism 122, for example, the pulley and belt mechanism is adopted. The roller driving motor 121 and the driving mechanism 122 are arranged in respect to each of the two porous rollers 110 (a first porous roller and a second porous roller).

Furthermore, the scrub washing apparatus 100 includes an x-direction moving mechanism 130 which serves as a mechanism allowing the two porous rollers 110 (the first porous roller and the second porous roller) to move in a direction between the axes thereof (x direction which will be described below). Two x-direction moving mechanisms 130 are provided respectively corresponding to the two rotary mechanisms 120. The x-direction moving mechanism 130 includes an x-direction moving servo motor 131 which controls the distance between the axes, and an x-direction moving table 132 which supports and moves the rotary mechanism 120. Each of the x-direction moving mechanisms 130 is arranged for each of the two porous rollers 110 (the first porous roller and the second porous roller) in order to change the distance in the x direction of each of the two porous rollers 110 (the first porous roller and the second porous roller). As a result, the two porous rollers 110 (the first porous roller and the second porous roller) are allowed to move in the distance between the axes thereof, and to maintain the distance between the axes.

Furthermore, the scrub washing apparatus 100 is provided with a y-direction moving mechanisms 140 which is a mechanism for reciprocating the porous rollers 110 in a direction of the axis thereof (y direction which will be described below). In the present exemplary embodiment, two y-direction moving mechanisms 140 are respectively provided so that the two x-direction moving mechanisms 130 reciprocate in the y direction. Each of the y-direction moving mechanisms 140 includes a y-direction moving servo motor 141 which is a driving source for the movement in the y direction, and a y-direction moving table 142 which supports and moves the x-direction moving mechanism 130.

Furthermore, the scrub washing apparatus 100 includes a nozzle 151 which sprays a washing liquid to the disk-shaped substrate 10. In the three-step (three-stage) scrub-washing shown in FIG. 2, washing liquids which include different components are sprayed from the nozzles 151. However, a washing liquid to be used may be selected in accordance with the composition of slurry which is used for grinding and polishing in the preceding process.

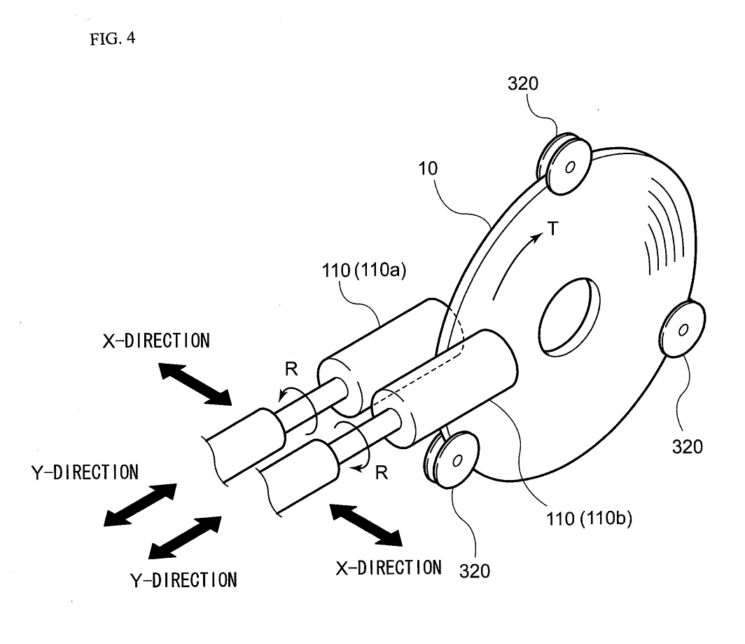

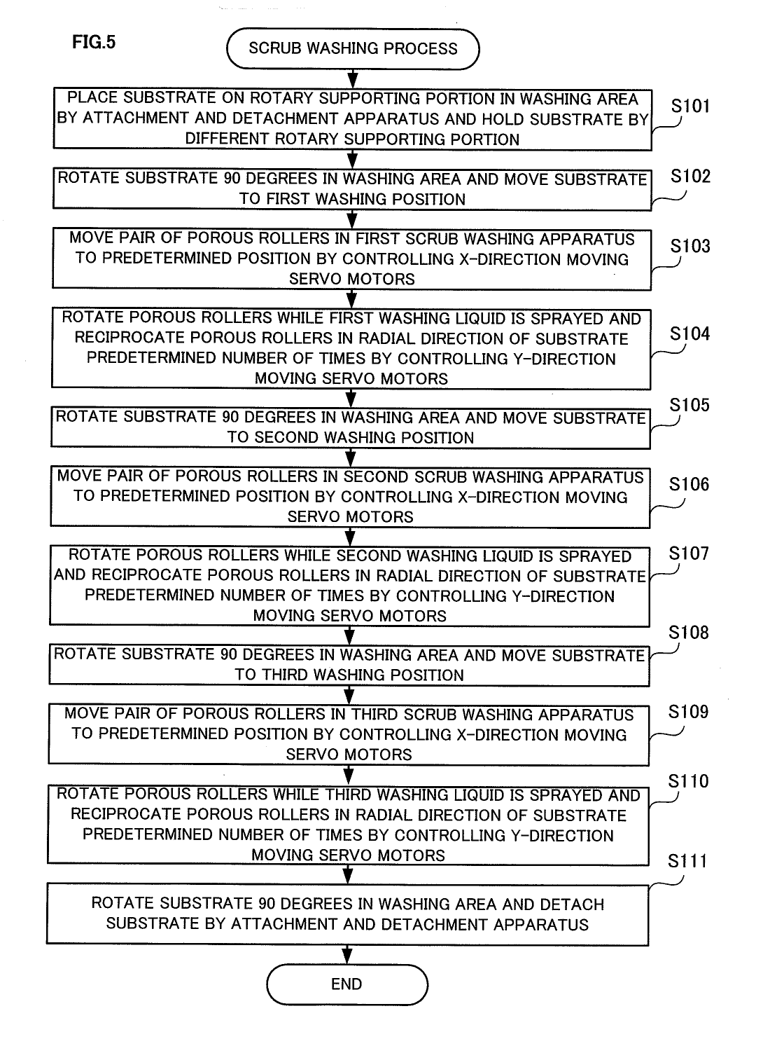

FIG. 4 is an explanatory view illustrating the state in which the pair of porous rollers 110 (the first porous roller 110a that may come in contact with a first surface of the disk-shaped substrate 10, and the second porous roller 110b that may come in contact with a second surface of the disk-shaped substrate 10) of the scrub washing apparatus 100 scrub-wash the disk-shaped substrate 10 to be washed. The disk-shaped substrate 10 is supported at three points by three rotary supporting portions 320 so as to be revolvable. By the two x-direction moving mechanisms 130 shown in FIG. 3, the pair of porous rollers 110 is movable in the x direction shown in FIG. 4. During the washing, the first porous roller 110a and the second porous roller 110b are moved to make the position of the axes thereof closer, and are stopped at a predetermined position of the axes. At this point, the first porous roller 110a and the second porous roller 110b are stopped upon coming in contact with the disk-shaped substrate 10. Thereafter, by the two rotary mechanisms 120 shown in FIG. 3, the first porous roller 110a and the second porous roller 110b are rotated in R directions shown in FIG. 4. The rotations in the R directions cause the disk-shaped substrate 10 which is in contact with the porous rollers 110 to be rotated in the T direction shown in the figure. Furthermore, the first porous roller 110a and the second porous roller 110b are reciprocated at the same time in the y direction shown in FIG. 4 (in the direction of the axes of the porous rollers 110, and the radial direction of the disk-shaped substrate 10) by the two y-direction moving mechanisms 140 shown in FIG. 3, while rotating in the R directions.

As for the pair of porous rollers 110 (the first porous roller 110a and the second porous roller 110b), for example, a roller made of polyvinyl alcohol (PVA) which is a hydrophilic polymer is used. Hence, compared to existing sponge rollers, a harder roller is employed. To be more specific regarding the degree of hardness, for example, a roller which has an average Asker F hardness of approximately 85 is preferably used. By using a roller having a relatively high hardness, the contact between the disk-shaped substrate 10 and the porous rollers 110 (the first porous roller 110a and the second porous roller 110b) becomes more of a line than a plane in a conventional method. Thereby, uniformity in the physical contact state of the porous rollers 110 to the disk-shaped substrate 10 is achieved, and, as a result, the washing condition in the contacting portions may be improved.

Next, a description is given to the flow of a scrub washing treatment which is performed by using the scrub washing apparatus 100 described above.

FIG. 5 is a flowchart which illustrates the scrub washing process. The flowchart is explained by referring to FIGS. 2 to 4. Firstly, the attachment and detachment apparatus 200 picks up, by using a predetermined pick-up apparatus (not shown in the figure), the disk-shaped substrate 10 to be scrub-washed which has been transferred via, for example, a conveyer (not shown in the figure), and then places the disk-shaped substrate 10 to rotary supporting portions 320 in the washing area 300. Thereafter, a different rotary supporting portion 320 holds the disk-shaped substrate 10 (step 101). Thereafter, the disk-shaped substrate 10 is rotated 90 degrees in the washing area 300, and then moved to a first washing position (stage) (step 102).

The first scrub washing apparatus 100a provided in the first washing position moves the pair of porous rollers 110 (the first porous roller 110a and the second porous roller 110b) to the predetermined position by bringing them closer to each other in the x direction in FIG. 4 by controlling the pair of x-direction moving servo motors 131 (step 103). The predetermined position is an axis-to-axis position (an axis-to-axis distance) which is set by confirming the contact state between the pair of porous rollers 110 and a workpiece in view of the thickness of the disk-shaped substrate 100 which is the workpiece. A high degree of control by the x-direction moving servo motor 131 conducts the position determination. Thereafter, while the first washing liquid is sprayed, the pair of porous rollers 110 (the first porous roller 110a and the second porous roller 110b) are rotated in the R direction in FIG. 4 by driving the roller driving motors 121. At the same time, the pair of porous rollers 110 (the first porous roller 110a and the second porous roller 110b) are both reciprocated simultaneously in the y direction (the radial direction of the disk-shaped substrate 10) shown in FIG. 4 a predetermined number of times by controlling the pair of y-direction moving servo motors 141 (step 104). At this time, the disk-shaped substrate 10 is driven to rotate in the T direction as a result of the R-direction rotation of the porous rollers 110.

Here, the range in which the pair of porous rollers 110 (the first porous roller 110a and the second porous roller 110b) come in contact with the disk-shaped substrate 10 by being reciprocated in the y-direction (the radial direction of the disk-shaped substrate 10) is the radial direction of the disk-shaped substrate 10, that is, one-half of the difference between the external diameter and the internal diameter of the disk-shaped substrate 10. When the porous rollers 110 go beyond the center of the disk-shaped substrate 10 and come in contact with two radial direction areas which are formed in the diameter direction of the disk-shaped substrate 10 at the same time, the driven rotation in the T direction in FIG. 4 is restrained; thus, a good washing effect is not acquired. In other words, since the direction of the acting force on the rollers becomes opposite in respect of the center of the disk-shaped substrate, the rotation of the disk-shaped substrate caused by the rotation of the rollers become unstable; thus, a stable washing effect is not achieved. For this reason, the range of contact in the reciprocating movement of the porous rollers 110 is determined to be within the range of one-half of the difference between the external diameter and the internal diameter of the disk-shaped substrate 10. By having the disk-shaped substrate 10 rotating in the T direction, the whole disk-shaped substrate 10 is washed by using the porous rollers 110 which are in contact with only the radial area of the disk-shaped substrate 10 by the reciprocating movement.

Then, the disk-shaped substrate 10 is rotated 90 degrees in the washing area 300 and is moved to the second washing position (step 105).

The second scrub washing apparatus 100b arranged in the second washing position moves the pair of porous rollers 110 (the first porous roller 110a and the second porous roller 110b) to the predetermined position by bringing them closer to each other in the x direction in FIG. 4 by controlling the pair of x-direction moving servo motors 131 (step 106). The predetermined position is set similarly to the case of the above-described first scrub washing apparatus 100a. Thereafter, while the second washing liquid is sprayed, the pair of porous rollers 110 are rotated in the R direction in FIG. 4 by driving the roller driving motors 121. At the same time, the pair of porous rollers 110 are reciprocated simultaneously in the y direction (the radial direction of the disk-shaped substrate 10) shown in FIG. 4 a predetermined number of times by controlling the pair of y-direction moving servo motors 141 (step 107). By the operation, the washing at the second washing position is finished.

Then, the disk-shaped substrate 10 is further rotated 90 degrees in the washing area 300 and is moved to the third washing position (step 108).

The third scrub washing apparatus 100c arranged in the third washing position moves the pair of porous rollers 110 (the first porous roller 110a and the second porous roller 110b) to the predetermined position by bringing them closer to each other in the x direction in FIG. 4 by controlling the pair of x-direction moving servo motors 131 (step 109). The predetermined position is set similarly to the case of the above-described first scrub washing apparatus 100a (and second scrub washing apparatus 100b). Thereafter, while the third washing liquid is sprayed, the pair of porous rollers 110 are rotated in the R direction in FIG. 4 by driving the roller driving motors 121. At the same time, the pair of porous rollers 110 are reciprocated simultaneously in the y direction (the radial direction of the disk-shaped substrate 10) shown in FIG. 4 a predetermined number of times by controlling the pair of y-direction moving servo motors 141 (step 110). By these operations, the washing at the third washing position is finished.

Thereafter, the disk-shaped substrate 10 is rotated 90 degrees in the washing area 300. Thus, the washed disk-shaped substrate 10 is moved to the attachment and detachment position. The disk-shaped substrate 10 is detached by the attachment and detachment apparatus 200 (step 111). Consequently, a sequence of the scrub washing process is finished.

It should be noted that attaching, the first scrub-washing to the third scrub-washing, and detaching are carried out at the same time in the four work areas which are located orthogonally to each other as shown in FIG. 2. Therefore, the scrub washing process shown in FIG. 5 is continuously conducted upon staggering the treatments. In this way, time required for the process may be reduced significantly.

Next, an example where the present exemplary embodiment is adopted is shown below.
Disk type: 1.89 inches
The disk-shaped substrate 10

External diameter: 48 mm

Internal diameter: 12 mm

Thickness: 0.55 mm
The porous roller 110

Material: PVF (polyvinyl formal)

Hardness: average asker F hardness of 80 to 95 (85−5 to 85+10)

Shape: external diameter 24 mm, internal diameter 8 mm, length 40 mm
At each step (stage)

Feeding amount in x direction: 20 mm±3 mm

Feeding amount in y direction: about 10 mm

Number of times of the movement in y direction (reciprocation): 4 times

Rotation number of the porous roller 110: 300 rpm

In this case, following expression is evaluated. (External diameter−internal diameter)/2=(48−12)/2=18 mm

Therefore, when the feeding amount in the y direction is approximately 10 mm, the range of contact between the pair of porous rollers 110 having a length of 40 mm and the disk-shaped substrate 10 is 18 mm as calculated in the above expression.

As a result of the test in the example described above, the number of particles having a size of 0.25 μm or more is reduced from an average of 10 per one surface before the washing down to an average of 3 or less per one surface after the washing. Furthermore, no variation in washing condition in different regions on the disk-shaped substrate 10 is observed; thus, good washing is achieved on the whole disk-shaped substrate 10.

Next, a description is given to a modified example of the present exemplary embodiment.

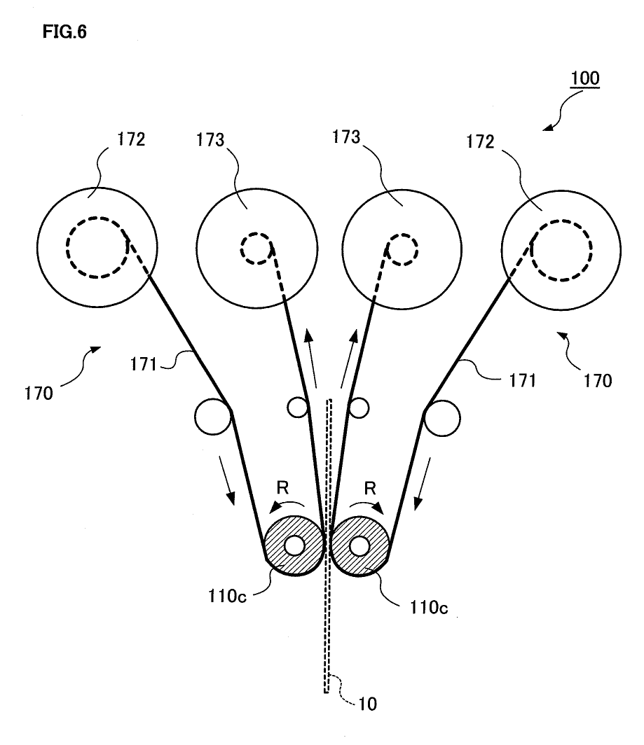

FIG. 6 is a view illustrating a different example of the scrub washing apparatus 100. The scrub washing apparatus 100 shown in FIG. 6 is characterized by including tape units 170. For example, in the case where more precise washing in the first scrub washing apparatus 100 (100a) shown in the FIG. 2 and the like is required, the tape unit 170 may be used. Two tape units 170 are respectively provided to a pair of rollers 110c. Each of the tape units 170 includes a tape 171 extending via a corresponding porous roller 110, a tape feed portion 172 which feeds the tape 171, and a tape reel portion 173 which reels the tape 171. The tapes 171 in the individual tape units 170 come in contact with the disk-shaped substrate 10 to be used for scrub-washing. As for the tape 171, for example, non-woven cloth and a plastic fiber impregnated with a polishing member are used. Furthermore, the roller 110c having the tape extending thereto is provided in place of the porous rollers 110. The materials of the roller 110c are, for example, polyvinyl formal (PVF), polyacetal (POM), polybutylene terephthalate (PBT), and polyethylene terephthalate (PET).

In the present modified example, the scrub washing apparatus 100 similarly brings the pair of rollers 110c closer to each other in the x direction in FIG. 4 by controlling a pair of x-direction moving servo motors 131. The pair of rollers 110c is caused to move to a predetermined position where the tape 171 comes in contact with the disk-shaped substrate 10, and is then stopped. Thereafter, the rollers 110c are rotated in the R directions and reciprocated in the y direction shown in FIG. 4 while a washing liquid is sprayed. When the rollers 110c are rotated, the tapes 171 extending via the rollers 110c are rotated in the directions indicated by the arrows in FIG. 6. As a result, a fresh surface of the tape 171 sequentially comes in contact with the disk-shaped substrate 10. In this configuration, particles on the disk-shaped substrate 10 may be more effectively removed. Especially, in the case where a large amount of particles are present, more preferable scrub-washing may be performed.

As mentioned above in detail, in the present exemplary embodiment, the variation in washing ability in different regions is reduced; thus, uniform washing may be achieved. In conventional scrub-washing, washing is performed on a disk substrate by holding the substrate between, for example, soft sponges, which are pressed on to both surfaces of the disk using, for example, an air cylinder. In such a method, some particles remain on the substrate, resulting in, for example, only one side having defects. However, according to the present exemplary embodiment, washing members (the porous rollers 110 and the tapes 171) come in contact with the disk-shaped substrate 10 in an area that is more of a line shape, in comparison with the case where this configuration is not adopted. As a result, the contact to the disk-shaped substrate 10 is maintained well; thus, uneven washing may be prevented by effectively removing particles which adhere on the activated surface of the disk-shaped substrate 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A disk-shaped substrate manufacturing method comprising:
scrub-washing a first surface and a second surface of a disk-shaped substrate by respectively using a first porous roller and a second porous roller that have a cylindrical shape and are rotationally driven,
the process of the scrub-washing determining a distance between axes of the first porous roller and the second porous roller that sandwich the disk-shaped substrate in between, and performing scrub-washing while the determined distance between the axes is under control.

2. The disk-shaped substrate manufacturing method according to claim 1, wherein the first porous roller and the second porous roller are driven to reciprocate in a radial direction of the disk-shaped substrate.

3. The disk-shaped substrate manufacturing method according to claim 2, wherein the first porous roller and the second porous roller come in contact with the disk-shaped substrate within a range of one-half of a difference between an external diameter and an internal diameter of the disk-shaped substrate, by driven to reciprocate.

4. The disk-shaped substrate manufacturing method according to claim 1, wherein the first porous roller and the second porous roller have an Asker F hardness in a range from 80 to 95.

5. A washing apparatus that performs scrub-washing on a first surface and a second surface of a disk-shaped substrate while supplying a washing liquid, the washing apparatus comprising:
a first porous roller that is able to come in contact with the first surface of the disk-shaped substrate and has a cylindrical shape;
a second porous roller that is arranged so as to face the first porous roller, is able to come in contact with the second surface of the disk-shaped substrate, and has a cylindrical shape; and
an axis-to-axis distance changing mechanism that changes a distance between axes of the first porous roller and the second porous roller,
the axis-to-axis distance changing mechanism stopping the first porous roller and the second porous roller at a predetermined axis-to-axis distance, and causing the first porous roller and the second porous roller to come in contact with the disk-shaped substrate.

6. The washing apparatus according to claim 5, further comprising:
a rotary mechanism that rotates the first porous roller and the second porous roller that are in contact with the disk-shaped substrate after the first porous roller and the second porous roller are moved and stopped at the predetermined axis-to-axis distance by the axis-to-axis distance changing mechanism; and
a reciprocating moving mechanism that reciprocates, in a radial direction of the disk-shaped substrate, the first porous roller and the second porous roller rotated by the rotary mechanism while stopped at the predetermined axis-to-axis distance by the axis-to-axis distance changing mechanism.

7. The washing apparatus according to claim 6, wherein the reciprocating moving mechanism reciprocates the first porous roller and the second porous roller to bring the first porous roller and the second porous roller in contact with the disk-shaped substrate within a range of one-half of a difference between an external diameter and an internal diameter of the disk-shaped substrate, and causes the first porous roller and the second porous roller to reciprocate a plurality of number of times.

8. The washing apparatus according to claim 5, wherein the axis-to-axis distance changing mechanism includes a first servo motor that moves the first porous roller and a second servo motor that moves the second porous roller, and controls the predetermined axis-to-axis distance.
